(19) United States
(12) Patent Application Publication
(10) Pub. No.: US 2015/0201032 A1
(43) Pub. Date: Jul. 16, 2015

(54) PROXY SERVER AND NETWORK COMMUNICATION METHOD THEREOF

(71) Applicant: Wistron Corporation, New Taipei City (TW)

(72) Inventor: Chun-Ching Chen, New Taipei City (TW)

(21) Appl. No.: 14/483,203

(22) Filed: Sep. 11, 2014

(30) Foreign Application Priority Data
Jan. 14, 2014 (TW) 103101320

(51) Int. Cl. H04L 29/08; G06F 11/07

(52) U.S. Cl. CPC H04L 67/28; G06F 11/0709; G06F 11/079

(57) ABSTRACT

The network communication method comprises the following steps. First, a command is received from an application platform. Then, the command is interpreted as an interpreted command complying with a command format of a manufacturer. Next, the interpreted command is sent to a gateway note, wherein the gateway node performs operations by using commands having the command format of the manufacturer.

This application claims the benefit of Taiwan application Serial No. 103101320, filed Jan. 14, 2014, the disclosure of which is incorporated by reference herein in its entirety.

### TECHNICAL FIELD

The disclosure relates in general to a proxy server and a network communication method thereof, and more particularly to a proxy server capable of integrating gateways/sensors of heterogeneous network protocols and a network communication method using the same.

### BACKGROUND

Reacting to the development of networking technology and the demands for digital home applications, various sensing units are used to transmit the status information of the power-saving devices or the security monitoring equipments. The sensing units upload the status information to the cloud management system, so that the user can control the home appliances remotely.

However, a system is difficult to connect various sensors using specific or unstandardized specs and protocols, and a cloud platform is difficult to support all kinds of manufacturer specs. If the support of different specs is required, it has to spend a lot of time and manpower to develop the system or platform. Conventionally, for example, if a user wants to setup gateways or sensors having different manufacturer specs, the user has to login respective settings pages of these gateways or sensors to enter the corresponding commands of different manufacturers, but this takes a lot of time and is inconvenient to integrate heterogeneous networks.

Therefore, there is a need for a network technology capable of integrating and connecting the gateways or sensors of heterogeneous network protocols.

### SUMMARY

The disclosure is directed to a proxy server and a network communication method thereof. By interpreting the user commands to a command complying with the manufacturer command format, the user does not need to respectively enter the corresponding commands to control the gateway equipments or sensors having different manufacturer specs. Therefore, the gateways or sensors of heterogeneous network protocols can be integrated easily, and the time needed to develop a program and the labor cost can be significantly reduced.

According to an aspect the disclosure, a network communication method for a proxy server is provided. The network communication method comprises the following steps. First, a command is received from an application platform. Then, the command is interpreted as an interpreted command complying with a command format of a manufacturer. Next, the interpreted command is sent to a gateway note, wherein the gateway node performs operations by using commands having the command format of the manufacturer.

According to another aspect the disclosure, a network communication method for a proxy server is provided. The network communication method comprises the following steps. First, data is received from a gateway node. Then, the data is parsed according to a manufacturer command format to generate a parsed data. Next, program syntax is used to package the parsed data to generate a command. After that, the command is sent to an application platform.

According to yet another aspect the disclosure, a proxy server is provided. The proxy server comprises a first interface, a data control module and a second interface. The first interface is configured to receive a data from a gateway node. The data control module is configured to parse the data according to a manufacturer command format to generate a parsed data, and is further configured to use program syntax to package the parsed data to generate a command. The second interface is configured to send the command to an application platform.

### BRIEF DESCRIPTION OF THE DRAWINGS

FIG. 1 illustrates a network configuration schematic diagram of a proxy server according to an embodiment of the disclosure.

FIG. 2 illustrates a block diagram of the proxy server.

FIG. 3 illustrates a flow chart of a network communication method of the proxy server.

FIG. 4 illustrates a flow chart of a network communication method of the proxy server.

FIG. 5 illustrates a block diagram of a proxy server according to another embodiment of the disclosure.

FIG. 6 illustrates the flow chart of the network communication method of the proxy server.

FIG. 7 illustrates the flow chart of the network communication method of the proxy server.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

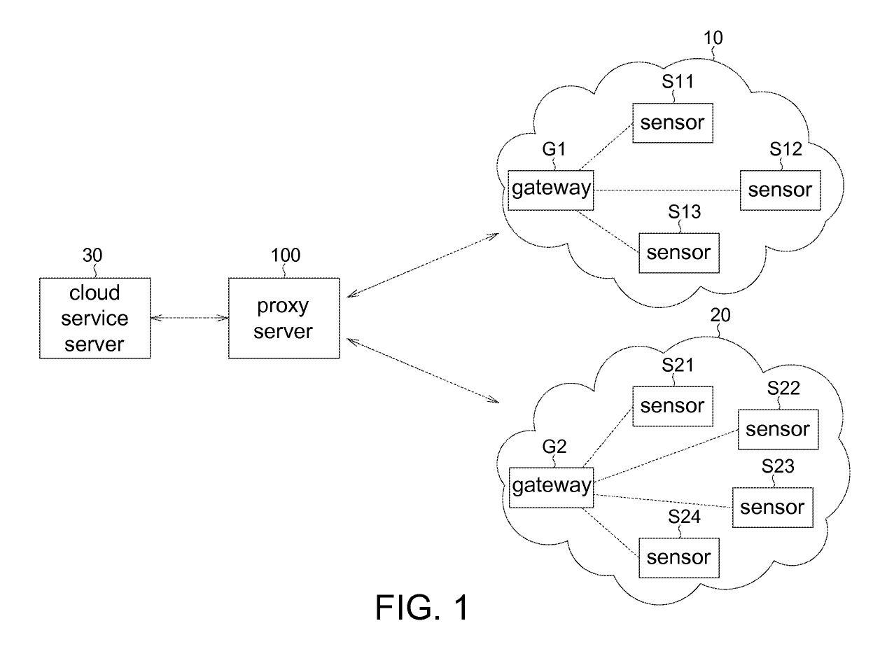

Referring to FIG. 1, it illustrates a network configuration schematic diagram of a proxy server 100 according to an embodiment of the disclosure. The network configuration includes a first local area network (LAN) 10, a second LAN 20, a proxy server 100 and a cloud service server 30. The first LAN 10 comprises a first gateway G1 and a plurality of first sensors S11, S12 and S13. The first sensors S11, S12 and S13 connect to an external network through the first gateway G1, and communicate with the cloud service server 30 via the proxy server 100. The second LAN 20 comprises a second gateway G2 and a plurality of second sensors S21, S22 and S23 and S24. Similarly, the second sensors S21, S22, S23 and S24 connect to an external network through the second gateway G2, and communicate with the cloud service server 30 via the proxy server 100. Each of the first and second gateways G1, G2 can be defined as a gateway node.

The first and second sensors S11, S12, S13, S21, S22, S23 and S24 may be, for example, various types of sensors such as physiological sensors, positioning sensors, disaster prevention sensors, shift detectors, positioning sensors, webcams or power meters that are capable of generating corresponding sensing data and transmitting them to corresponding gateways G1 and G2 in a wired or wireless way. In this example, the manufacturer of the first gateway G1 (ex., the manufacturer A) is different from the manufacturer of the second gateway G2 (ex., the manufacturer B). Therefore, the command format of the operating commands associated with the first gateway G1 is different from the command format of the operating commands of the second gateway G2. That is, the first LAN 10 and the second LAN 20 belong to different heterogeneous network protocols, respectively.

The proxy server 100 of the embodiment of the disclosure is capable of integrating the heterogeneous network protocols to provide a standardized communication interface protocol. Thus, the user can control the gateways or sensors of heterogeneous network protocols at the cloud service server 30 by standardized operating commands. For example, when a user login the cloud service server 30 through a mobile device, a personal computer or other kind of electronic device, the user can obtain the list of the sensors S11, S12, S13, S21, S22, S23 and S24 located in the first and second LANs 10, 20 just by entering a standardized command of “GetNodeList” into the application platform of the cloud service server 30, without entering respective commands for the two heterogeneous LANs 10 and 20. Moreover, with the help of the integration of the proxy server 100, the user can read the sensing data of the sensors S11, S12, S13, S21, S22, S23 and S24 just by entering a standardized command at the application platform, without entering different kinds of “ReadSensingData” commands for gateways with different brands.

It is understood that the abovementioned first and second LANs 10, 20 are given for illustration purposes, not for restriction purposes, as the proxy server of the disclosure can be used to integrate gateways of various heterogeneous networks in accordance with the principles of the disclosure.

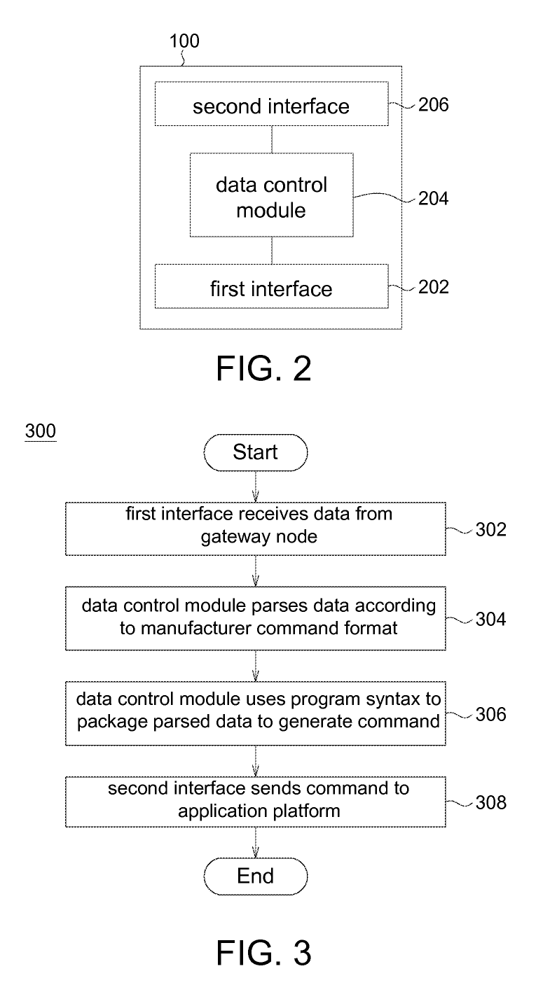

Referring to FIG. 2, it illustrates a block diagram of the proxy server 100. The proxy server 100 comprises a first interface 202, a data control module 204 and a second interface 206. The first interface 202 may be, for example, a TCP/IP protocol interface for communicating with the gateway nodes (ex., gateways) on the network. The data control module 204 can be realized by program modules or hardware circuits. The data control module 204 is used for transforming or packaging the related commands, and is used for dismantling and parsing the commands to texts or symbols that can be perceived by the user. The second interface 206 can be a simple object access protocol (SOAP) interface, a web services description language (WSDL) interface, or a universal description, discovery, and integration (UDDI) interface. The second interface 206 is used for sending the commands generated by the data control module 204 to the application platform.

FIG. 3 illustrates a flow chart of a network communication method 300 of the proxy server 100. The network communication method 300 is an upstream transmission process that represents the operations of the proxy server 100 when the gateway nodes transmit data to the application platform.

At step 302, the first interface 202 receives data from a gateway node. The data may be, for example, sensing data obtained from the sensors. The data is transmitted to the first interface 202 of the proxy server 100 through the gateway node by TCP/IP protocol.

At step 304, the data control module 104 parses the data according to a manufacturer command format to generate a parsed data. For example, the data control module 104 determines which manufacturer is corresponding to the data received from the gateway node, and automatically executes the parsing command of the determined manufacturer to parse the data according to the manufacturer command format. In short, the data control module 104 can determine the gateway node manufacturer to which the data corresponds, and determine the manufacturer command format according to the gateway node manufacturer. In the embodiment, the passed data at least comprises transmission information such as a sequence number column, a time stamp column, a session identification column and a media access control address column. In an example, the transmission information is temperately stored in an array to wait for subsequent processing.

At step 306, the data control module 104 using program syntax to package the parsed data to generate the command. For example, the data control module 104 uses standard program syntax to package the parsed data to generate the commands according to the transmission meaning (ex., sequence number, time stamp and so on) represented by the parsed data temperately stored in the array. The program syntax can be SOAP syntax, WSDL syntax or UDDI syntax.

At step 308, the second interface 206 sends the command to an application platform. Taking the command packaged from SOAP syntax as an example, since SOAP syntax is publicly available, a remote application platform can use or call the command easily. Therefore, the proxy server 100 of the embodiments of the disclosure has the advantage of easily supporting different application platform services.

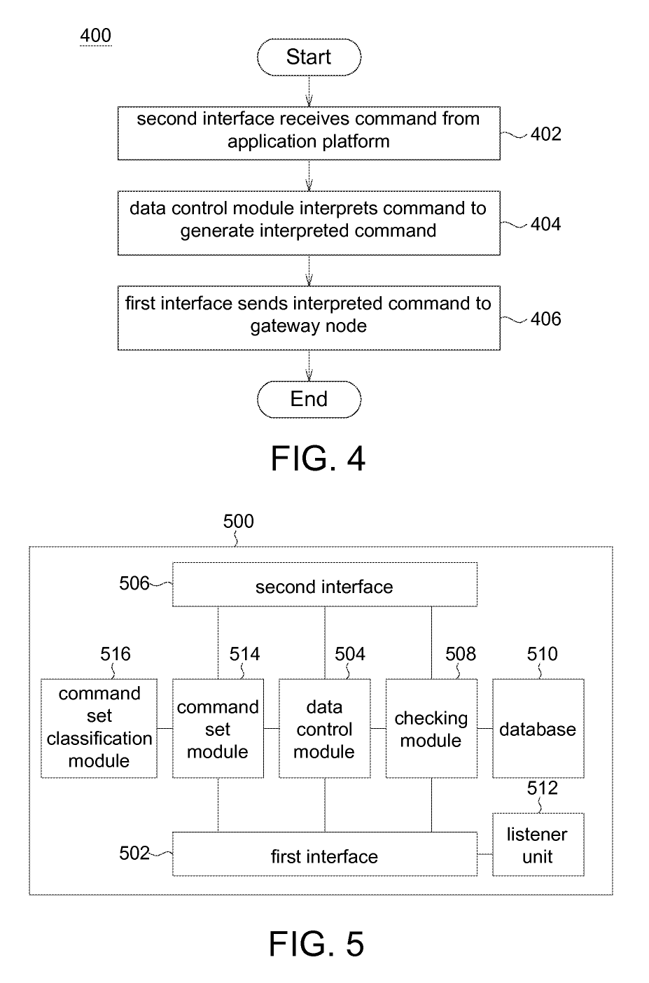

FIG. 4 illustrates a flow chart of a network communication method 300 of the proxy server 100. The network communication method 400 is a downstream transmission process that represents the operations of the proxy server 100 when the application platform transmits commands to the gateway nodes (to control the gateway nodes or the sensors belonging to the gateway nodes).

At step 402, the second interface 206 receives a command from the application platform. The command may be used to control the gateway nodes or the sensors belonging to the gateway nodes. For example, the user can use the command to read the sensing data of the sensors or to setup the gateway nodes.

At step 404, the data control module 204 interprets the command to generate an interpreted command. The interpreted command complies with a command format of a manufacturer. For example, the data control module 204 may first determine the gateway node manufacturer to which the command corresponds according to the parameters of the command (ex., the gateway node manufacturer information), and then interpret the command as an interpreted command complying with an command format of the gateway node manufacturer.

For example, if a “GetNodeList” command entered by the user is consist of 26 bits, these bits may comply with a command format of a specific node equipment manufacturer, where the return values of the 1^{st} and 2^{nd} bits may indicate a sequence number; the 3^{rd} to 10^{th} bits may indicate a time stamp (i.e., the timing of transmitting the current data); the 11^{th} bit may indicate a session identification number (ex., 0x00 indicates a server, 0x01 indicates a gateway node and the machine codes start from 0x02 indicate the other 254 nodes or sensors); the 21^{st} and 22^{nd} bits may indicate a product identification number; the return bit 149 may indicate the voltage of a node is 110V; the return bit 150 may indicate the voltage of a node is 220V; the return value 170 may indicate that a node is a alarm; the return value 165 may indicate that a node is a carbon dioxide sensor; the 23^{rd} and 24^{th} bits may indicate an object ID; the 25^{th} bit may indicate a reserved bit; the 26^{th} bit may indicate a checking number. It is understood that the disclosure is not limited to the above examples. The command format of the interpreted command can be different depending on the command formats adopted by the manufacturer.

At step 406, the first interface 202 sends the interpreted command to the gateway node. Because the gateway node is corresponding to a specific manufacturer, the gateway node works only when using a command with a command format of the specific manufacturer. Accordingly, an interpreted command complying with a command format of the gateway node manufacturer can be used by the gateway node.

According to the above, the proxy server of the embodiment of the disclosure is capable of integrating a plurality of heterogeneous network protocols corresponding to different node equipment manufacturers. Through the proxy server of the embodiment of the disclosure, the user just needs to enter a standardized command, and the standardized command can be automatically transformed to have a command format applicable to the gateway node. Moreover, the proxy server of the embodiment of the disclosure can parse and package the sensing data obtained from the sensing nodes of heterogeneous networks, so different application platforms can be easily supported.

Referring to FIG. 5, it illustrates a block diagram of a proxy server 500 according to another embodiment of the disclosure. The proxy server 500 comprises a first interface 502, a data control module 504, a second interface 506, a checking module 508, a database 510 and a listener unit 512. The proxy server 500 may optionally further comprise a command set module 514 and a command set classification module 516. The functions of the first interface 502, the data control module 504 and the second interface 506 are similar to the previous embodiment, so a detailed description thereof is omitted.

During the upstream transmission, the checking module 508 may check whether the data received from the gateway node is correct. For example, the checking module may compare the data with a predetermined data stored in the database 510. If the data does not comply with the predetermined data, the checking module 508 sends back an error message to the application platform. In an example, the predetermined data comprises data templates complying communication specs, and/or command templates corresponding to command formats of a plurality of manufacturers. In another example, the proxy server 500 does not comprise the database 510. At this time, the checking module 508 obtains the predetermined data by accessing databases external to the proxy server 500.

During the upstream transmission, the checking module 508 determines whether the command is correct by checking the syntax of the command (ex. a SOAP command) generated by the data control module 504. If the checking module 508 determines that the command is incorrect, it sends back a corresponding error message to the application platform. For example, the checking module 508 may determine whether a stream transmitted from a gateway note of a manufacturer is empty. If so, it means the SAOP command corresponding to the stream is error. In such situation, the checking module 508 executes an exception process to send an error message to the application platform. Further, for example, if the user successfully gives a command to a shift detector but fails to receive the data sent back from the shift detector (such error may be regarded as an equipment limitation), the checking module 508 also executes the exception process.

On the other hand, during the downstream transmission, the checking module 508 determines whether the interpreted command complies with the command format of the manufacturer. For example, the checking module 508 compares the interpreted command with a predetermined data stored in the database 510. If the checking module 508 determines that the interpreted command does not comply with the predetermined data, it sends back an error message to the application platform.

During the downstream transmission, the checking module 508 determines whether the command sent from the application platform is correct. If the checking module 508 determines that the command is incorrect, it sends back a corresponding error message to the application platform. For example, the checking module 508 checks whether the command is able to link a remote gateway node after receiving the command from the application platform. If the command fails to link the remote gateway node, the checking module 508 executes an exception process such as sending back a corresponding error message to the application platform.

The listener unit 512 is used for detecting whether the gateway node performs data transmission. The listener unit 512 may be, for example, a resident software service. The listener unit 512 starts when the proxy server 500 starts, so as to detect the data sent from each gateway node.

In the embodiment, the proxy server 500 may optionally comprise a command set module 514 and a command set classification module 516. The command set module 514 is used for storing at least one command set. For example, the command set module 514 stores a predetermined command set which comprises all the commands related to communicate with the gateway nodes.

After the proxy server 500 receives the command form the application platform, the command set classification module 516 may select, from the command set module 514, a predetermined command set to which the command belongs. By calling the predetermined command set to which the command belongs, the related program modules in the proxy server 500 can access the command fast, so that the overall program operation can be speeded-up.

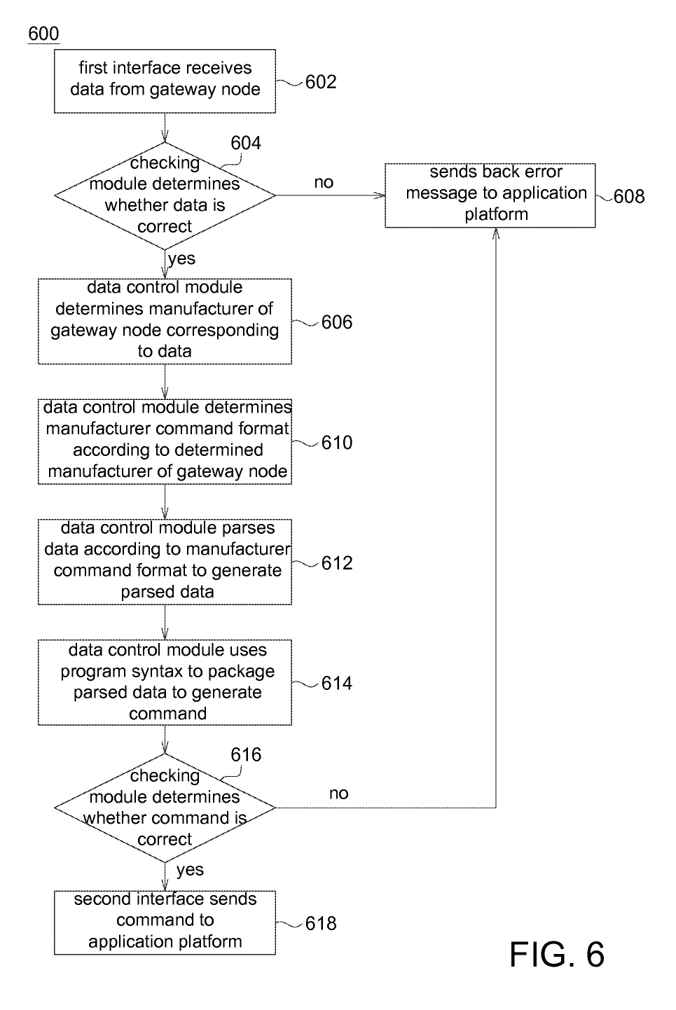

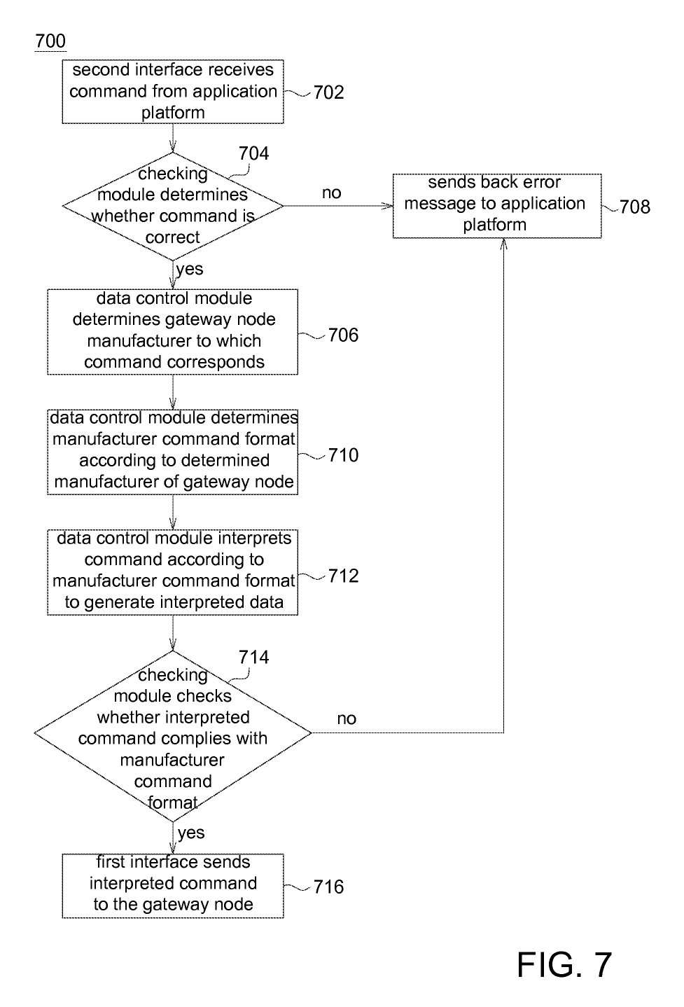

For better illustrations of the operation of the proxy server 500, descriptions are given with reference to the network communication method flow charts shown in FIGS. 6 and 7.

Referring to FIG. 6, it illustrates the flow chart of the network communication method 600 of the proxy server 500. The network communication method 600 is a process of upstream transmission. At step 602, the first interface 502 receives the data from the gateway node. At step 604, the checking module 508 determines whether the data is correct. If so, step 606 is executed, and the data control module 504 determines a manufacturer of the gateway node corresponding to the data. If not, step 608 is executed, and the checking module 508 sends back an error message to the application platform. At step 610, the data control module 504 determines the manufacturer command format according to the determined manufacturer of the gateway node. At step 612, the data control module 504 parses the data according to the manufacturer command format to generate a parsed data. At step 614, the data control module 504 uses program syntax to package the parsed data to generate the command. At step 616, the checking module 508 determines whether the command is correct. If so, the step 618 is executed, and the second interface 506 sends the command to the application platform. If not, the flow goes back to step 608, and the checking module 508 sends back an error message to the application platform. In an example, before the second interface 506 sends the error message to the application platform (i.e., before step 618), the command set classification module 516 may select a predetermined command set to which the command belongs from the command set module 514, so that the application platform can call the predetermined command set easily in the subsequent process.

Referring to FIG. 7, it illustrates the flow chart of the network communication method 700 of the proxy server 500. The network communication method 700 is a process of downstream transmission. At step 702, the second interface 506 receives the command from the application platform. At step 704, the checking module 508 determines whether the command is correct. If so, step 706 is executed, and the data control module 504 determines the gateway node manufacturer to which the command corresponds. If not, step 708 is executed, and the checking module 508 sends back an error message to the application platform. At step 710, the data control module 504 determines the manufacturer command format according to the determined manufacturer of the gateway node. At step 712, the data control module 504 interprets the command according to the manufacturer command format to generate an interpreted data. At step 714, the checking module 508 checks whether the interpreted command complies with the manufacturer command format. If so, the step 716 is executed, and the first interface 502 sends the interpreted command to the gateway node. If not, the flow goes back to step 708, and the checking module 508 sends back an error message to the application platform. In an example, after the second interface 506 receives the command from the application platform (i.e., after step 702), the command set classification module 516 may select a predetermined command set to which the command belongs from the command set module 514, so that the application platform can call the predetermined command set easily in the subsequent process.

Based on above, the proxy server of the embodiment of the disclosure is capable of integrating a plurality of heterogeneous network protocols corresponding to different node equipment manufacturers. Through the proxy server of the embodiment of the disclosure, the user just needs to enter a standardized command, and the standardized command can be automatically transformed to have a command format applicable to the gateway node. Moreover, the proxy server of the embodiment of the disclosure can parse and package the sensing data obtained from the sensing nodes of heterogeneous networks, so different application platforms can be easily supported.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A network communication method for a proxy server, comprising:
receiving a command from an application platform;
interpreting the command as an interpreted command complying with an command format of a manufacturer; and
sending the interpreted command to a gateway note, wherein the gateway node performs operations by using commands having the command format of the manufacturer.

2. The network communication method according to claim 1, wherein the step of interpreting the command as an interpreted command further comprises:
determining a gateway node manufacturer corresponding to the command;
determining the command format corresponding to the gateway node manufacturer; and
checking whether the interpreted command complies with the command format.

3. The network communication method according to claim 2, wherein the step of checking whether the interpreted command complies with the command format further comprises:
comparing the interpreted command with a predetermined data stored in a database; and
sending back an error message to the application platform when the interpreted command does not comply with the predetermined data.

4. The network communication method according to claim 1, further comprising:
determining whether the command is correct; and
sending back an error message to the application platform when the command is incorrect.

5. The network communication method according to claim 1, further comprising:
determining a predetermined command set to which the command belongs before the command is interpreted; and
calling the predetermined command set to which the command belongs.

6. The network communication method according to claim 1, wherein the interpreted command at least comprises a sequence number column, a time stamp column, a session identification column and a media access control address column.

7. A network communication method for a proxy server, comprising:
receiving data from a gateway node;
parsing the data according to a manufacturer command format to generate a parsed data;
using program syntax to package the parsed data to generate a command; and
sending the command to an application platform.

8. The network communication method according to claim 7, wherein the step of generating a parsed data further comprises:
checking whether the data is correct;
determining an manufacturer of the gateway node corresponding to the data; and
determining the manufacturer command format according to the manufacturer of the gateway node.

9. The network communication method according to claim 8, wherein the step of checking whether the data is correct further comprise:
comparing the data with a predetermined data stored in a database to determine whether the data is correct; and
sending back an error message to the application platform when the data is determined to be incorrect.

10. The network communication method according to claim 7, further comprising:
checking the program syntax of the command to determine whether the command is correct; and
sending back an error message to the application platform when the command is determined to be incorrect.

11. The network communication method according to claim 7, further comprising:
determining a predetermined command set to which the command belongs before transmitting the command to the application platform; and
calling the predetermined command set to which the command belongs.

12. The network communication method according to claim 7, wherein the parsed data at least comprises a sequence number column, a time stamp column, a session identification column and a media access control address column.

13. The network communication method according to claim 7, wherein the program syntax is at least one of simple object access protocol (SOAP), web services description language (WSDL) or universal description, discovery, and integration (UDDI).

14. A proxy server, comprising:
a first interface for receiving a data from a gateway node;
a data control module for parsing the data according to a manufacturer command format to generate a parsed data, and using a program syntax to package the parsed data to generate a command; and
a second interface for sending the command to an application platform.

15. The proxy server according to claim 14, wherein the data control module determines a manufacturer of the gateway node corresponding to the data, and further determines the manufacturer command format according to the manufacturer of the gateway node.

16. The proxy server according to claim 14, further comprising:
a checking module for comparing the data with a predetermined data stored in a database;
wherein the checking module sends back a first error message to the application platform when the data does not comply with the predetermined data.

17. The proxy server according to claim 16, wherein the checking module checks the program syntax of the command to determine whether the command is correct;
wherein the checking module sends back a second error message to the application platform when determining the command is incorrect.

18. The proxy server according to claim 17, further comprises:
a command set module for storing at least one command set; and
a command set classification module for selecting, from the command set module, a predetermined command set to which the command belongs;
wherein the application platform accesses the command by calling the predetermined command set to which the command belongs.

19. The proxy server according to claim 14, further comprises:
a listener unit for detecting whether the gateway node performs data transmission.

20. The proxy server according to claim 14, wherein the second interface is at least one of simple object access protocol (SOAP), web services description language (WSDL) or universal description, discovery, and integration (UDDI).
